(19) United States
(12) Patent Application Publication
(10) Pub. No.: US 2003/0127237 A1
(43) Pub. Date: Jul. 10, 2003

(54) Check mechanism for rotary shaft of pneumatic tool

(75) Inventor: Hsin-Chi Chen, Taiping City (TW)

Correspondence Address: DAVID E. DOUGHERTY, SUITE 1404, 5205 LEESBURG PIKE, FALLS CHURCH, VA, 22041, US

(73) Assignee: TRANMAX MACHINERY CO., LTD.

(21) Appl. No.: 10/040,494

(22) Filed: Jan. 9, 2002

(51) Int. Cl. B25B 19/00

(52) U.S. Cl. 173/104; 173/90

(57) ABSTRACT

Check mechanism for rotary shaft of pneumatic tool, including: a ratchet section having a ratchet wheel coaxially fixedly connected with the rotary shaft and synchronously rotatable with the rotary shaft, multiple ratchets being arranged on a circumference of the ratchet wheel; a click section having a click stem movable between an acting position and a releasing position, when the click stem is positioned in the acting position, one end of the click stem resiliently engaging with the ratchets of the ratchet section to restrict the ratchet wheel to one-way rotate and prevent the rotary shaft from rotating backward, when the click stem is positioned in the releasing position, click stem being disengaged from the ratchets of the ratchet section, whereby the ratchet section is released from the checking of the click stem; and a locating section for locating the click stem in the acting position or releasing position.

### BACKGROUND OF THE INVENTION

The present invention is related to a pneumatic tool, and more particularly to a check mechanism for rotary shaft of a pneumatic tool.

A conventional pneumatic tool utilizes high-pressure air as pressure source for driving a rotor to rotate. A power transmission mechanism is used to transmit the power of the rotor to an output end for actual application. An impact mechanism is widely used in the pneumatic tool as the power transmission mechanism. In general, the impact mechanism includes a hollow hammer and a stem-like block coaxially disposed in the interior of the hammer. The hammer is driven by the rotor to repeatedly hammer the block to make the block rotate. U.S. patent application Ser. No. 09/986,543 of this applicant discloses a torque-restricting structure for impact mechanism to overcome the shortcomings existing in such impact mechanism. The torque-restricting structure provides a power transmission mechanism which ensures that the output torque is restricted within a safe range.

The present invention is an auxiliary mechanism for the above Patent Application so as to achieve an optimal stable state of engagement between the hammer and the block. In the above Patent Application, a connecting section is disposed in a specific position between the annular hammer and the stem-like block to connect the hammer with the block. Accordingly, in a specific moving direction, the hammer and the block are drivingly connected. Accordingly, the rotor, the hammer and the block are integrally operated so as to avoid too great instantaneous torque in the impact transmission. However, prior to the instant of connection between the hammer and the block, the hammering impact may still lead to slight back rotation of the hammer due to reaction force of the block. This may result in that the connection between the hammer and the block is obstructed. Therefore, it is tried by the applicant to provide a measure to solve the above problem.

### SUMMARY OF THE INVENTION

It is therefore a primary object of the present invention to provide a check mechanism for rotary shaft of a pneumatic tool. The check mechanism is able to restrict the rotary shaft of the pneumatic tool to only one-way rotate.

According to the above object, the check mechanism for rotary shaft of pneumatic tool of the present invention includes: a ratchet section having a ratchet wheel coaxially fixedly connected with the rotary shaft and synchronously rotatable with the rotary shaft, multiple ratchets being arranged on a circumference of the ratchet wheel; a click section having a click stem movable between an acting position and a releasing position, when the click stem is positioned in the acting position, one end of the click stem resiliently engaging with the ratchets of the ratchet section to restrict the ratchet wheel to one-way rotate and prevent the rotary shaft from rotating backward, when the click stem is positioned in the releasing position, click stem being disengaged from the ratchets of the ratchet section, whereby the ratchet section is released from the checking of the click stem; and a locating section for locating the click stem in the acting position or releasing position.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 shows the guide notch of the click stem of the present invention in a stretched state;

FIG. 4 is a side sectional assembled view of the present invention applied to a pneumatic tool;

FIG. 5 is a front sectional assembled view of the present invention applied to a pneumatic tool;

FIG. 6 is a sectional view showing the operation of the present invention, in which the click section is positioned in the acting position; and

FIG. 7 is a sectional view showing the operation of the present invention, in which the click section is positioned in the releasing position.

### DETAILED DESCRIPTION OF THE PREFERRED EMBODIMENTS

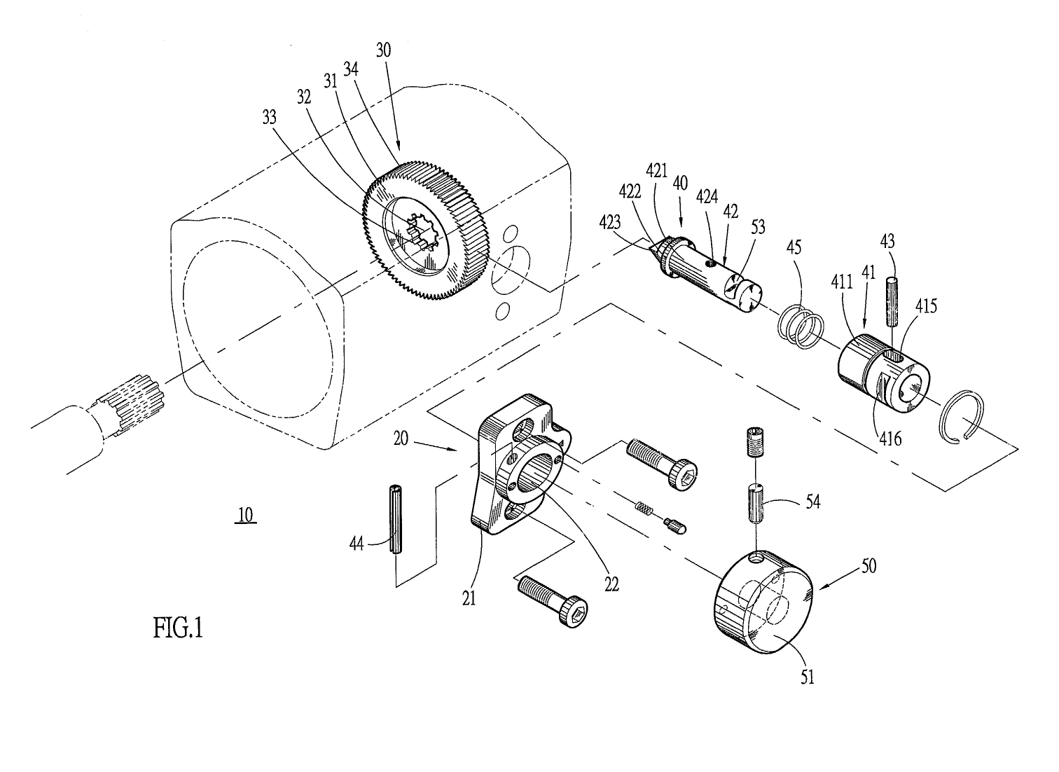

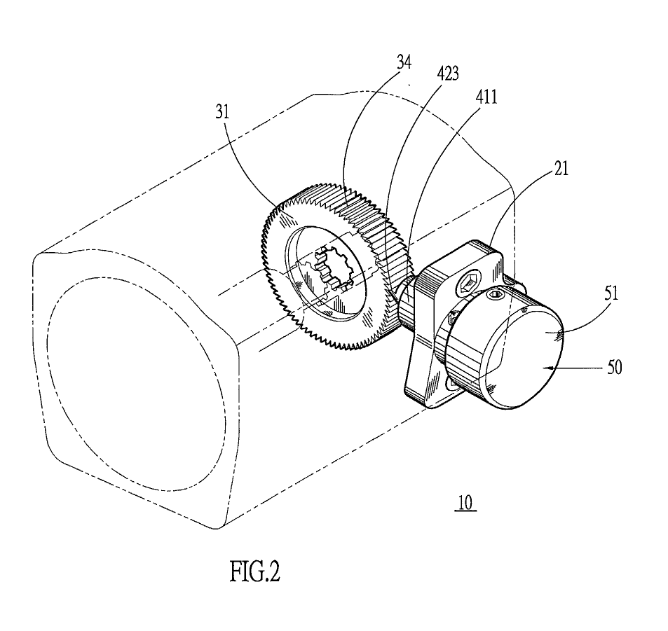

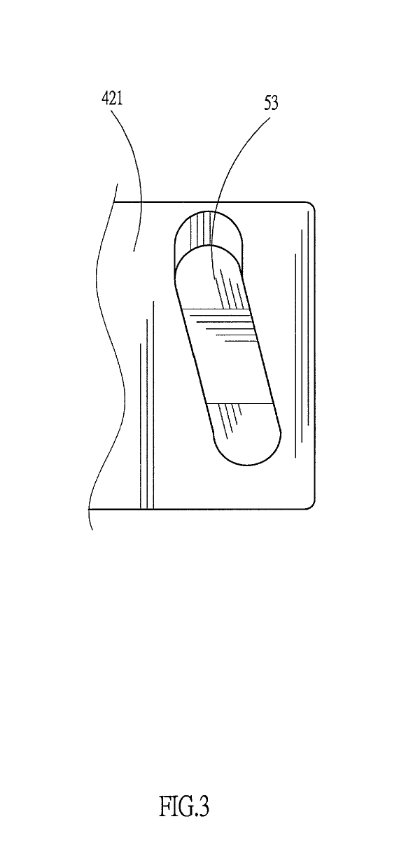

Please refer to FIGS. 1 to 4. The check mechanism 10 for rotary shaft of pneumatic tool of the present invention includes a base seat 20, a ratchet section 30, a click section 40 and a locating section 50.

The base seat 20 has a board body 21 formed with a receiving hole 22 passing through the board body 21 from one face to the other face.

The ratchet section 30 includes a ratchet wheel 31 formed with a shaft hole 32 passing through the ratchet wheel 31 from one face to the other face. Multiple engaging dents 33 are formed on the wall of the shaft hole 32. Multiple ratchets 34 are arranged on the circumference of the ratchet wheel 31 at equal intervals.

The click section 40 includes a sleeve 41, a click stem 42, a restricting pin 43, a fixing pin 44 and a spring 45.

The sleeve 41 has a tubular body 411 coaxially fixedly fitted through the receiving hole 22 of the base seat 20. The interior of the sleeve 41 is axially sequentially divided into a small diameter section 412, a large diameter section 413 and an annular shoulder section 414 between the large and small diameter sections 412, 413. Two slide slots 415 with a certain length are formed on the tubular body 411 on opposite sides thereof. The slide slots 415 communicate inner and outer sides of the small diameter section 412 of the tubular body 411. The major axes of the slide slots 415 are parallel to the axis of the tubular body 411. A fixing notch 416 is formed on the outer wall of the tubular body 411 in a certain position.

The click stem 42 has a cylindrical stem body 421 extending through the tubular body 411 of the sleeve 41. One end of the stem body 421 extends out of the opening of the large diameter section 413 of the tubular body 411. The other end extends out of the opening of the small diameter section 412 of the tubular body 411. A flange 422 is formed on the circumference of one end of the stem body 421. The outer diameter of the flange 422 is not larger than the inner diameter of the large diameter section 413 of the tubular body 411. A wedged block 423 is formed on the end of the stem body 421 and adjacent to the flange 422. A through hole 424 is formed on the middle of the stem body 421. Two ends of the through hole 424 are respectively correspondingly adjacent to the slide slots 415.

The restricting pin 43 is fitted through the through hole 424 with two ends respectively extending into the slide slots 415, whereby the click stem 42 is restricted to only axially reciprocally axially move within the length of the slide slots 415.

The fixing pin 44 is disposed on the base seat 20 and engaged in the notch 416 for fixing the sleeve 41 and preventing the sleeve 41 from rotating.

A spring 45 is fitted around the stem body 421 of the click stem. Two ends of the spring 45 respectively abut against the flange 422 and the shoulder section 414 for resiliently pushing the end of the click stem 42 outward.

In addition, the locating section 50 includes a rotary block 51. A socket 52 with a certain depth is formed on one face of the rotary block 51. The other end of the click stem 42 extends into the socket 52. An obliquely extending arched guide notch 53 is formed on the circumference of the other end of the stem body 421 of the click stem 42. The distances between the other end of the stem body 421 and a first and a second positions of two ends of the guide notch 53 are different. To speak more specifically, the distance between the other end of the stem body 421 and the first position is larger than the distance between the other end of the stem body 421 and the second position. One end of a pin-like guide member 54 extends into the guide notch 53, while the other end thereof is located on the rotary block 51, whereby the click stem 42 and the rotary block 51 are connected by the guide member 54.

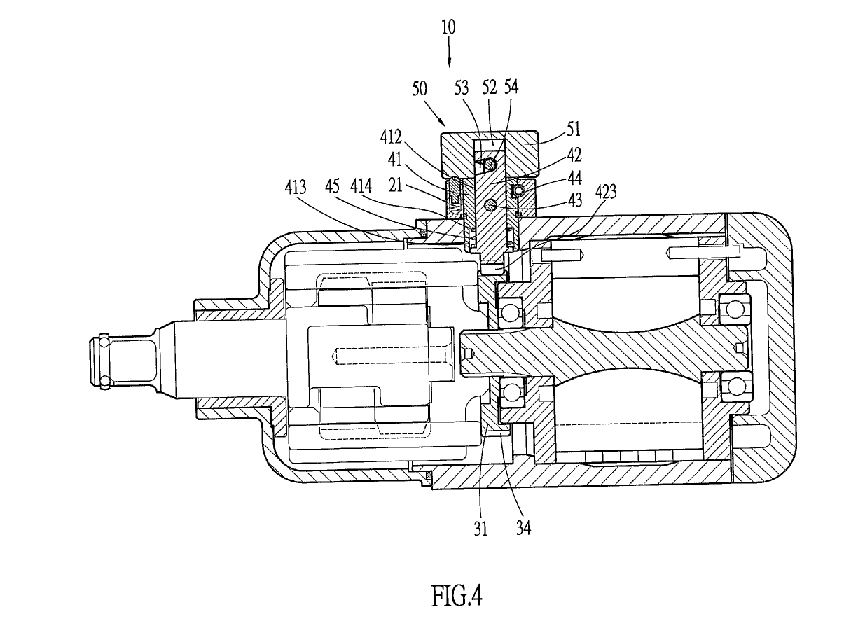

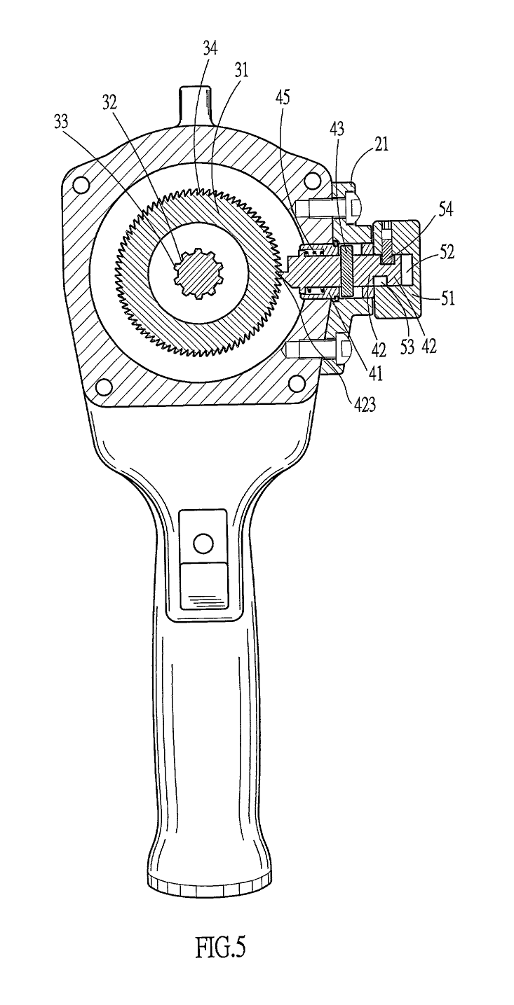

Referring to FIGS. 4 to 7, in use of the check mechanism 10, the ratchet section 30 is fitted on the rotary shaft of the pneumatic tool with the rotary shaft passing through the shaft hole 32. The engaging ribs of the rotary shaft are engaged with the engaging dents 33, whereby the ratchet section 30 is synchronously rotatable with the rotary shaft. The board body 21 of the base seat 20 is fixed on outer side of a housing of the pneumatic tool by screws. The housing is formed with a through hole coaxially corresponding to the receiving hole 22. When mounting the click section 40 on the base seat 20, the wedged block 423 can extend into the housing to engage with the ratchets 34 of the ratchet section 30. The click stem 42 is restricted to only axially move within the length of the slide slots 415 between an acting position and a releasing position. The locating section 50 serves to locate the click section 40 in the acting position or releasing position.

When in the acting position, the click section 40 resiliently abuts against the ratchet section 30 to restrict the ratchet section 30 to one-way rotate. When the rotary shaft of the pneumatic tool suffers a reaction force and tends to rotate backward, the click section 40 is engaged with the ratchet section 30 to check the rotary shaft from rotating backward.

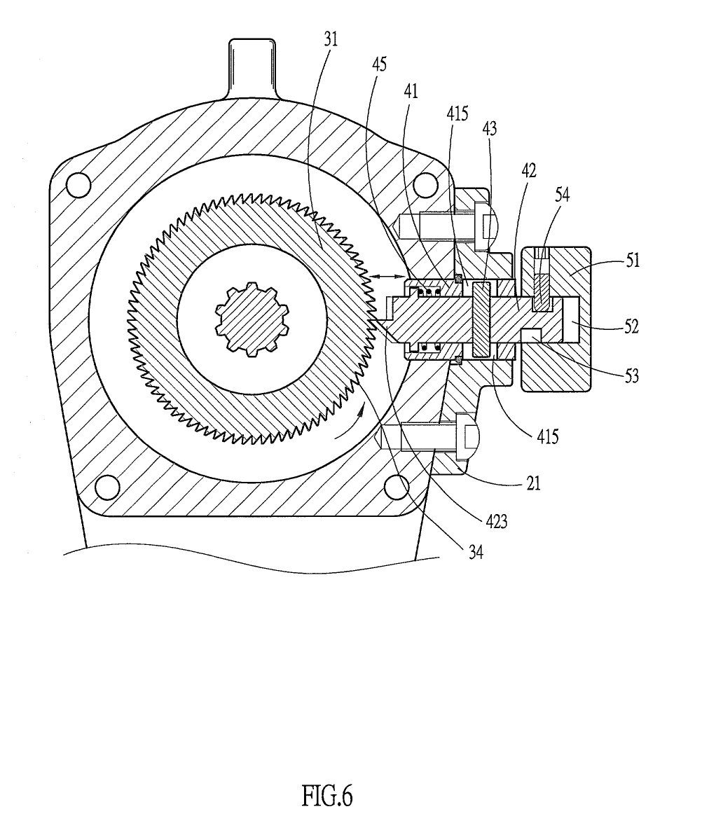

The pin-like guide member 54 of the locating section 50 is engaged in the first position of the guide notch 53, whereby one end of the click stem 42 extends into the pneumatic tool. The spring 45 provides a certain resilience, whereby the wedged block 423 is able to engage with the ratchets 34 of the ratchet section 30. When the rotary shaft counterclockwise rotates as shown in FIG. 6, the click stem 42 and the locating section 50 at the other end thereof are simply resiliently located by the spring 45 so that when the ratchet section 30 rotates, the click stem 42 and the locating section 50 are simultaneously outward pushed and synchronously displaced. Accordingly, the wedged block 423 is such engaged with the ratchets 34 as to permit the ratchet wheel 31 to synchronously rotate with the rotary shaft.

However, when the rotary shaft counterclockwise rotates, the rotary shaft suffers a clockwise reaction force which may make the rotary shaft rotate backward. At this time, the click section 40 is located in the acting position and only permits the ratchet section 30 to rotate counterclockwise as shown in FIG. 6. Accordingly, the click section 40 cooperates with the ratchet section 30 in preventing the ratchet section 30 from rotating backward.

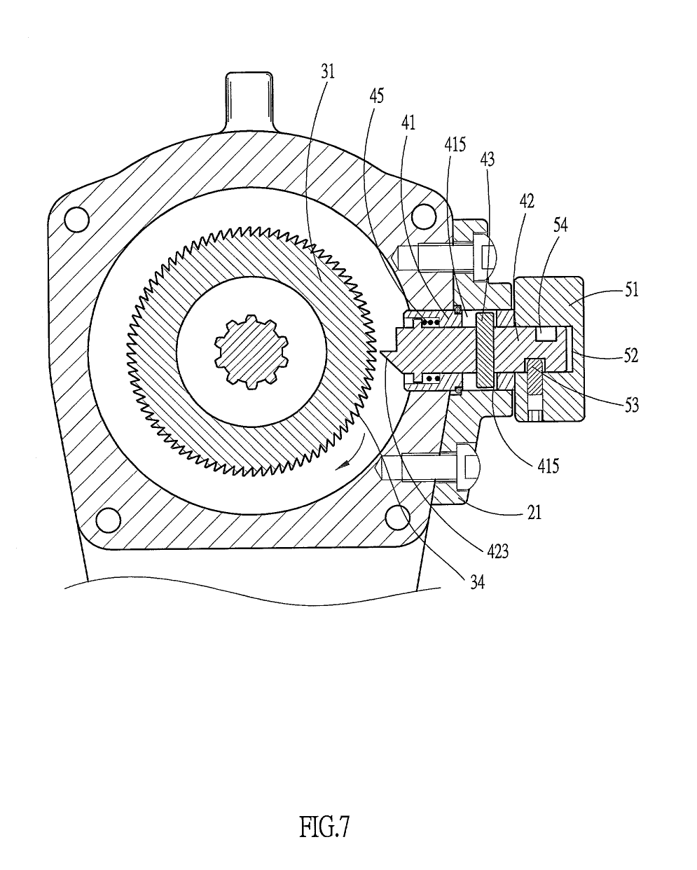

When in the releasing position, the wedged block 423 of the click section 40 is distal from the ratchets 34 of the ratchet section 30, whereby the ratchet section is able to freely rotate without restriction. When the click section 40 is moved from the acting position to the releasing position by means of rotating the rotary block 51 of the locating section 50 and making the pin-like guide member 54 move from the first position of the guide notch 53 to the second position. At this time, one face of the rotary block 51 abuts against one end of the sleeve 41 and the click stem 42 is outward pulled by a certain distance as shown in FIG. 7. Under such circumstance, the click section 40 is not engaged with the ratchet section 30 so that the ratchet section 30 and the rotary shaft of the pneumatic tool can freely rotate without being restricted. Accordingly, when the click section 40 is positioned in the releasing position, the rotary shaft of the pneumatic tool can clockwise rotate as shown in FIG. 7 as necessary.

The above embodiment is only used to illustrate the present invention, not intended to limit the scope thereof. Many modifications of the above embodiment can be made without departing from the spirit of the present invention.

What is claimed is:

1. Check mechanism for rotary shaft of pneumatic tool, comprising:
a ratchet section having a ratchet wheel coaxially fixedly connected with the rotary shaft and synchronously rotatable with the rotary shaft, multiple ratchets being arranged on a circumference of the ratchet wheel;
a click section having a click stem movable between an acting position and a releasing position, when the click stem is positioned in the acting position, one end of the click stem resiliently engaging with the ratchets of the ratchet section to restrict the ratchet wheel to one-way rotate and prevent the rotary shaft from rotating backward, when the click stem is positioned in the releasing position, click stem being disengaged from the ratchets of the ratchet section, whereby the ratchet section is released from the checking of the click stem; and
a locating section for locating the click stem in the acting position or releasing position.

2. Check mechanism for rotary shaft of pneumatic tool as claimed in claim 1, wherein the click section includes a sleeve coaxially fitted on a stem body of the click stem, whereby the click stem is restricted by the sleeve to only axially move between the acting position and releasing position.

3. Check mechanism for rotary shaft of pneumatic tool as claimed in claim 2, wherein the other end of the click stem extends out of a corresponding end of the sleeve to connect with the locating section, one side of the locating section being adjacent to the corresponding end of the sleeve.

4. Check mechanism for rotary shaft of pneumatic tool as claimed in claim 3, wherein the locating section includes a rotary block fitted on the other end of the click stem, an obliquely extending guide notch being formed on the circumference of the other end of the stem body of the click stem, one end of a guide member extending into the guide notch, while the other end of the guide member being fixed on the rotary block.

5. Check mechanism for rotary shaft of pneumatic tool as claimed in claim 4, wherein the guide notch is archly formed on the click stem between a first position and a second position, the distance between the other end of the click stem and the first position being larger than the distance between the other end of the click stem and the second position.

6. Check mechanism for rotary shaft of pneumatic tool as claimed in claim 2, wherein at least one slide slot is axially formed on the sleeve on one side thereof, the click section further including at least one restricting pin, one end of the restricting pin being perpendicularly fixed on the click stem, while the other end of the restricting pin being passed through the slide slot for restricting the click stem to only axially move within the length of the slide slot.

7. Check mechanism for rotary shaft of pneumatic tool as claimed in claim 2, wherein the click section further includes a spring which is fitted around the click stem, two ends of the spring respectively abutting against the sleeve and a flange formed on the circumference of one end of the click stem for resiliently pushing the end of the click stem away from the corresponding end of the sleeve.
